(19) United States
(12) Patent Application Publication
(10) Pub. No.: US 2010/0026941 A1
(43) Pub. Date: Feb. 4, 2010

(54) ELECTRO-OPTICAL DEVICE AND MANUFACTURING METHOD OF ELECTRO-OPTICAL DEVICE

(75) Inventors: Tomokazu UMENO, Suwa-shi (JP); Yoshiki NAKASHIMA, Suwa-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: SEIKO EPSON CORPORATION, Tokyo (JP)

(21) Appl. No.: 12/489,897

(22) Filed: Jun. 23, 2009

(30) Foreign Application Priority Data
Jul. 29, 2008 (JP) 2008-194500

(51) Int. Cl. G02F 1/1335; G02F 1/13

(52) U.S. Cl. 349/114; 349/113; 349/187

(57) ABSTRACT

An electro-optical device, includes a pair of substrates, a liquid crystal layer interposed between the pair of substrates, two electrodes optically modulating the liquid crystal layer in accordance with an electric field being generated by therebetween, a planarization layer configured to be included in one substrate from among the pair of substrates, the planarization layer configured to have a flat planar surface including at least one electrode formed thereon from among the two electrodes formed thereon, and concave portions configured to be formed in the flat planar surface of the planarization layer and be formed so that the depth of each of the concave portions is appropriate for causing an optical diffraction phenomenon.

### BACKGROUND

1. Technical Field

The present invention relates to an electro-optical device and a manufacturing method of the electro-optical device.

2. Field of Invention

Among electro-optical devices, liquid crystal display devices, in which a liquid crystal layer is interposed between a pair of substrates and the liquid crystal layer is optically modulated in accordance with an electric field generated between two electrodes, are employed in various electrical devices. In particular, a reflective liquid crystal display device, which has a reflective display function allowing light rays reflected by one of the pair of substrates to be optically modulated, and a transflective liquid crystal display device, which has a transmissive display function allowing light rays propagating through the pair of substrates to be optically modulated, in addition to the reflective display function, include therein a reflective display portion configured to display images by utilizing outside light, such as natural light or illumination light, and thus, either of the reflective liquid crystal display device or the transflective liquid crystal display device is widely used in electrical devices, such as mobile-phones, as a liquid crystal display device of low power consumption.

In such a reflective liquid crystal display device and a transflective liquid crystal display device, since reflection of outside light, such as natural light or illumination light, allows viewers to identify the content of display, an insufficient amount of the outside light leads to reduction of visibility of the reflective display portion included therein. Therefore, to date, in association with the reflective liquid crystal display device and the transflective liquid crystal display device, technologies, which enable improving of a visibility angle characteristic, such as a viewing angle, and suppressing reduction of the visibility of the reflective display portion, by scattering light rays reflected by a concavo-convex portion which is formed on the reflecting surface of the reflective display portion so as to reflect the outside light, have been proposed.

For example, in JP-A-2003-215317, a technology, which enables forming of a reflective electrode on the surface of a substrate, including surfaces of concave and convex portions formed by performing an exposure and development process for a photosensitive resin film formed on the substrate, is disclosed. Furthermore, in JP-A-2000-2875, a technology, which enables forming of a textured structure (i.e., concave and convex portions), which is composed of a material of low refractive index, on a reflective electrode, and further, on the textured structure, an optical reflecting film composed of a material of high refractive index, is disclosed.

However, the technology disclosed in JP-A-2003-215317 causes variation of the thickness of a liquid crystal layer existing above the reflecting surface having the concave and convex portions formed thereon, which is due to the shapes of the concave and convex portions, and this variation of the thickness of the liquid crystal layer due to shapes of concave and convex portions leads to a difference in lengths of light ray paths associated with light rays propagating through the liquid crystal layer, and as a result, is likely to cause a coloring phenomenon due to optical retardation of the liquid crystal layer.

In contrast, the technology disclosed in JP-A-2000-2875 provides a method which enables preventing of the variation of the thickness of the liquid crystal layer existing above the reflecting surface due to the shapes of the concave and convex portions, by forming the optical reflecting film on the textured structure of the concave and convex portions. Therefore, this method prevents occurrence of a difference in the lengths of light ray paths associated with light rays propagating through the liquid crystal layer due to shapes of the concave and convex portions, and as a result, causes no arising of the coloring phenomenon due to optical retardation of the liquid crystal layer. However, in this technology disclosed in JP-A-2000-2875, it is necessary to additionally provide an additional film used for forming of the textured structure on the reflecting electrode, and this necessity leads to a disadvantage in that a manufacturing procedure of the liquid crystal display device becomes more complicated and needs more processes.

### SUMMARY

Accordingly, it is desirable to provide an electro-optical device for which the above-described disadvantages are at least partially overcome, and as will be made obvious from the following application examples and embodiments, the electro-optical device can be realized.

### APPLICATION EXAMPLE 1

An electro-optical device according to an aspect of the invention having a liquid crystal layer which is interposed between a pair of substrates and is optically modulated in accordance with an electric field generated between two electrodes, includes a planarization layer configured to be included in one substrate among from the pair of substrates and have a flat planar surface including at least one electrode formed thereon from among the two electrodes formed thereon, and concave portions configured to be formed on the flat planar surface of the planarization layer and be formed so that the depth of each of the concave portions is appropriate for causing an optical diffraction phenomenon.

By providing such a configuration described above, since the concave portions function as a so-called diffractive optical element (DOE) causing the light diffractive phenomenon, an area in which the concave portions are formed becomes an area reflecting light rays diffusely, and thus, enables improving of a visibility angle characteristic associated with a display function provided by the liquid crystal display device. In this case, since the concave portions causing the light diffractive phenomenon are formed on the flat planar surface and the depth extending in a vertical direction from the flat planar surface is significantly small in size, compared with the thickness of the liquid crystal layer, the area in which the concave portions are formed can be regarded as an area being approximately planar. As a result, the thickness of a part of the liquid crystal layer existing within the area in which the concave portions are formed becomes substantially approximately constant. Accordingly, the probability of arising of misalignments in optical characteristics associated with the reflected light rays due to optical retardation of the liquid crystal layer, such as the resultant coloring phenomenon, is reduced. Furthermore, the above-described formation, which causes light rays to be scattered by forming concave portions in the planarization layer, leads to an advantage in that complexity of the manufacturing procedure of the liquid crystal display device is not increased.

### APPLICATION EXAMPLE 2

In the electro-optical device according to the foregoing application example 1, preferably, in the flat planar surface of the planarization layer, the concave portions are configured to form a random pattern which specifies a light scattering characteristic.

In this way, by changing the random pattern, it is possible to realize a light scattering characteristic specified by the changed random pattern, and thus, it is possible, for example, to provide a liquid crystal display device including a reflective display portion having a light scattering characteristic in accordance with a request from a user of the liquid crystal display device.

### APPLICATION EXAMPLE 3

Preferably, the electro-optical device according to the foregoing application example 1 further includes a reflecting layer configured to reflect light rays, be formed on the flat planar surface of the planarization layer, and be formed in portions where the concave portions are formed.

In such a way as described above, the area in which the concave portions are formed results in being surely a reflecting area by means of which light rays are reflected. Therefore, as a result, the reflecting area includes the concave portions in an approximately flat planar surface, which function as a diffractive optical element causing light rays to be reflected diffusely, and thus, function as a reflecting section which allows reflected light rays to be appropriately scattered. Therefore, a visibility angle characteristic associated with the liquid crystal layer can be improved.

### APPLICATION EXAMPLE 4

In the electro-optical device according to the foregoing application example 3, preferably, the reflecting layer is configured to form at least one part of the one electrode.

Such a configuration as described above allows the reflecting layer to function as the one electrode. Therefore, since it is not necessary to form the one electrode so as to be mounted on the reflecting layer, variation of the thickness of the liquid crystal layer due to the thickness of the one electrode formed so as to be mounted on the reflecting layer is suppressed. Therefore, differences in the light path lengths of light rays propagating through the liquid crystal layer are suppressed, and thus, the probability of arising of misalignments in optical characteristics associated with the light rays propagating through the liquid crystal layer due to optical retardation of the liquid crystal layer, such as the resultant coloring phenomenon, is reduced.

### APPLICATION EXAMPLE 5

In the electro-optical device according to the foregoing application example 3, preferably, the one electrode is composed of a transparent material having optical transparency, and on the flat planar surface of the planarization layer, the reflecting layer is formed within at least one part of an area where the one electrode is formed.

Such a configuration as described above allows an area in which the concave portions are formed to be a light-reflecting area in which the reflecting layer is formed, and an area in which the concave portions are not formed to be a light-transmitting area because of the transparency of the one electrode. As a result, the light-reflecting area and the light-transmitting area are formed on the same flat planar surface, and therefore, the thickness of the liquid crystal layer within the light-reflecting area and the thickness of the liquid crystal layer within the light-transmitting area result in causing a difference therebetween by only the thickness of the reflecting layer, and thus, are approximately the same. Accordingly, it is possible to achieve a transflective liquid crystal display device capable of reducing the probability of arising of misalignments in optical characteristics due to optical retardation of the liquid crystal layer, such as the resultant coloring phenomenon, between light rays emitted from the light-reflecting area and light rays emitted from the light-transmitting area.

### APPLICATION EXAMPLE 6

A manufacturing method of the electro-optical device described in the foregoing application example 1 includes forming a resist film covering the flat planar surface of the planarization layer, performing etching of the resist film formed thereby, and forming the concave portions by performing dry etching of the planarization layer, during which the resist film etched thereby is used as an exposure mask.

Such a method as described above enables forming of the concave portions by means of dry etching so that the concave portions can be configured so as to be appropriate for yielding a diffraction effect with respect to wavelengths of visible light rays, and thus, enables easily forming of a diffraction optical element. Furthermore, by changing an etching pattern of the resist film, it is possible to easily change a pattern formed by the concave portions. As a result, it is possible to easily change (i.e., customize) the pattern formed by the concave portions by changing the etching pattern of the resist film. As a result, the light scattering characteristic can be changed in accordance with the etching pattern, and therefore, for example, it is possible to provide a liquid crystal display device including a reflective display portion having a light scattering characteristic in accordance with a request from a user of the liquid crystal display device.

### APPLICATION EXAMPLE 7

In the manufacturing method of the electro-optical device, according to the foregoing application example 6, preferably, the forming of the concave portions concurrently includes removing of an insulating film covering an electrode terminal which is configured to supply the one electrode with a voltage causing the electric field to be generated.

This method allows forming of the concave portions concurrently with removing of the insulating film needed to electrically connect between the electrode terminal and the one electrode, and thus, enables forming of the diffraction optical element without increasing of the number of the etching processes.

### BRIEF DESCRIPTION OF THE DRAWINGS

FIG. 1 is a schematic diagram illustrating a liquid crystal display device which is a practical example of an electro-optical device according to aspects of the invention.

FIG. 2 is a plan view illustrating a configuration of one pixel.

FIG. 3 is a partially sectional view illustrating a configuration of one pixel.

FIGS. 4A to 4D are process diagrams sequentially illustrating processes of forming concave portions and a reflecting layer in an element substrate.

FIGS. 5A and 5B are diagrams each illustrating an example of a shape of mask pattern used for forming of concave portions.

FIGS. 6A and 6B are diagrams each illustrating a configuration of an element substrate in an example of a first modified practical example according to aspects of the invention.

FIG. 7 is a schematic diagram illustrating a configuration of an element substrate in a second modified practical example according to aspects of the invention.

FIG. 8 is a schematic diagram illustrating a configuration of an element substrate in a sectional view in a second modified practical example according to aspects of the invention.

FIG. 9 is a schematic diagram illustrating a configuration of an element substrate in plan view in a second modified practical example according to aspects of the invention.

### DESCRIPTION OF EXEMPLARY EMBODIMENTS

Exemplary embodiments of the invention will be hereinafter described by way of practical examples. In addition, in each drawing used for the following description, for the sake of easy understanding, sometimes, elements are illustrated at expanded scales, and as is obvious, all elements are not illustrated in proportion to their actual sizes and lengths.

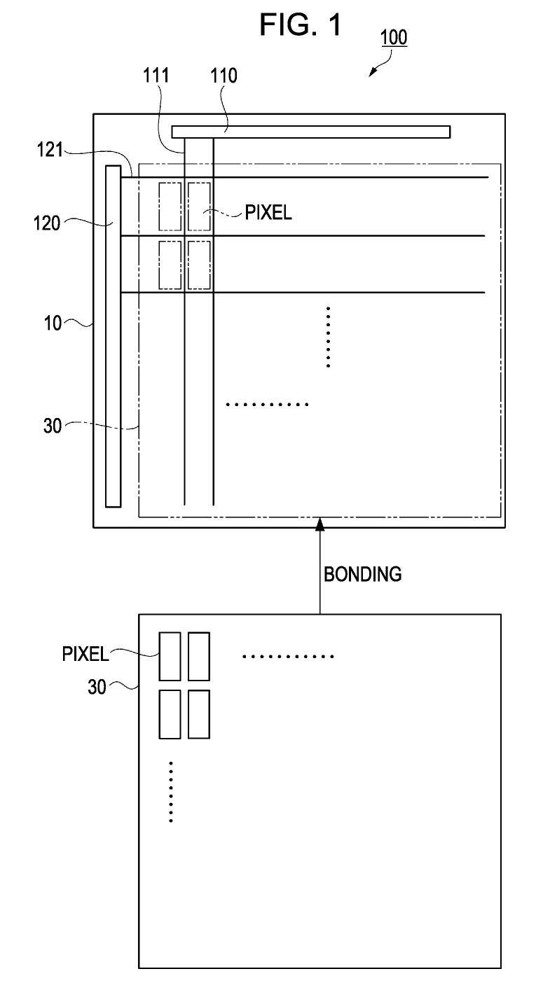

FIG. 1 is a schematic diagram illustrating a liquid crystal display device 100, which is a practical example of an electro-optical device according to an embodiment of the invention. The liquid crystal display device 100 is configured to include substrates 10 and 30 constituting a pair of substrates, the substrates 10 and 30 having a liquid crystal layer (shown in FIG. 1) interposed in a sealed condition therebetween and being bonded to each other by using a sealing material (also not shown in FIG. 1).

One substrate 10 of the pair of substrates is configured to include a scan driving circuit 120 and a data driving circuit 110 located in a peripheral area on a planar plate (formed at the front side of the drawing), which is composed of a material having transparency, such as glass, quartz or resin. Further, as shown in FIG. 1, scanning lines 121 and data lines 111 are wired from the scan driving circuit 120 and the data driving circuit 110, respectively. Moreover, each of the scanning lines 121 and each of the data lines 111 are configured to be supplied to a thin film transistor (not shown in FIG. 1) of a corresponding pixel and being located around a position at which the scanning line 121 and the data line 111 intersect each other, turning on/off of the thin film transistor being controlled in accordance with a voltage supplied via the scanning line 121, and immediately after the thin film transistor is turned on, a voltage supplied via the data line 111 is conducted through the thin film transistor to be applied to an electrode formed in the pixel.

The other substrate 30 of the pair of substrates is formed so that, area portions, each being located at a position corresponding to the position of a pixel for which optical modulation is performed, form light-transmitting regions, and the other area portions form light-shielding regions each including a prescribed light-shielding layer composed of a material, such as a metallic film, formed on a planar plate (formed at the back side of the drawing) composed of a material having transparency, such as glass, quartz or resin. In each of the light-transmitting regions, a filter layer is provided that can transmit only light rays having a prescribed wavelength. Therefore, light rays leaking between adjacent pixels are light-shielded by the light-shielding layer and light rays having a wavelength specified by the filter layer are emitted from the corresponding pixel area. Furthermore, an electrode is formed so as to cover all of the light-transmitting regions.

Moreover, the liquid crystal display device 100 is configured to include the substrate 10 and the substrate 20 bonded with each other so that, in each pixel, the electrode formed at the substrate 10 side (which will be hereinafter termed “a pixel electrode”) and the electrode formed at the substrate 30 side (which will be hereinafter termed “a common electrode”) are formed so as to have the liquid crystal layer interposed therebetween and be opposite each other. Therefore, each pixel is configured so that, immediately after the thin film transistor is turned on, a voltage difference between a voltage supplied via one of the data lines 111 and a voltage of the common electrode is applied to the liquid crystal layer corresponding to the pixel, so that light modulation is performed in the liquid crystal layer in accordance with the applied voltage difference.

Additionally, in the following description, in order not to confuse the substrate 10 and the substrate 30, the substrate 10 will be referred to as an element substrate 10 and the substrate 30 will be referred to as an opposite substrate 30.

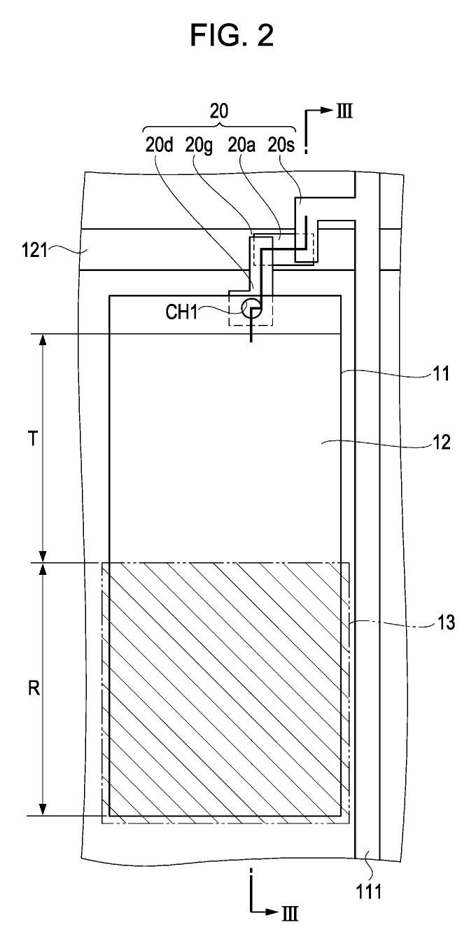

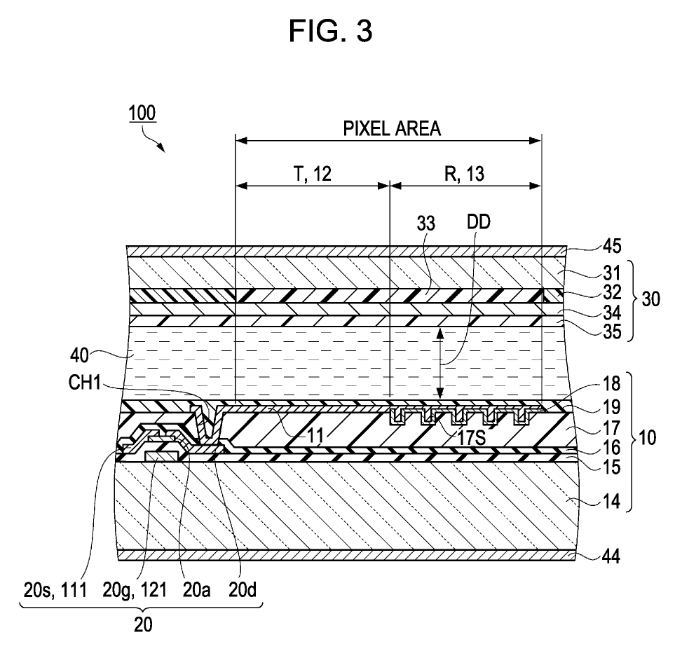

Next, a configuration of each of pixels included in the liquid crystal display device 100 will be described in detail with reference to FIGS. 2 and 3. FIG. 2 is a plan view illustrating a configuration of one pixel, which is viewed from the opposite substrate 30 side in a direction toward the element substrate 10 side and is viewed through the opposite substrate 30. Further, FIG. 3 is a partial sectional view of the configuration of the pixel. In addition, the liquid crystal display device 100 according to this practical example is a so-called transflective liquid crystal display device having pixel areas, each including a light-transmitting display area configured to transmit light rays emitted from an illumination section, which is formed at a side opposing the substrate 30 side of the element substrate 10, and a light-reflecting display area configured to reflect outside light rays, such as sunlight, incident from the opposite substrate 30 side.

As shown in FIG. 2, a thin film transistor is formed around a position at which one of the scanning lines 121 and one of data lines 111 intersect each other, the thin film transistor being formed of a source electrode 20s formed by extending the data line 111, a semiconductor layer 20a having a channel area therein, a gate electrode 20g for which the scanning line 121 concurrently functions, and a drain electrode 20d. Further, the drain electrode 20d is connected to a pixel electrode 11 via a contact hole CH1. Therefore, upon turning on of the thin film transistor 20 in accordance with a voltage supplied to the one of the scanning lines 121, i.e., the gate electrode 20g, a voltage supplied to the one of the data lines 111 is applied to the pixel electrode 11 via the drain electrode 20d, which operates as an electrode terminal configured to supply the liquid crystal layer with a voltage which causes an electric field to be generated inside the liquid crystal layer.

The pixel electrode 11 is composed of a light-transparent material having electrical conductivity (for example, ITO). In contrast, in an area portion, which is shown by hatching and is located at the lower side in FIG. 2, a light-reflecting area 13, having therein an area overlapping the pixel electrode 11 in plan view, is formed. Thus, an area portion 12, which is located within an area where the pixel electrode 11 is formed and is not included in the light-reflecting area 13, is an area through which light rays are transmitted. As a result, as shown in FIG. 2, a pixel area includes a light-transmitting display area T, through which light rays emitted from an illumination section provided inside the liquid crystal display device 100 are transmitted, and a light-reflecting display area R, by means of which outside light rays, such as light rays emitted from the sun, are reflected.

In addition, in this practical example, taking into account accuracy in bonding the element substrate 10 and the opposite substrate 30, the dimensions of the pixel electrode 11 are formed so as not to be smaller than the dimensions of the light-transmitting region formed in the opposite substrate 30 (i.e., the dimensions of the pixel area). Further, the contact hole CH1 is formed so as not to be exposed through the light-transmitting region.

Next, a cross-sectional configuration of a pixel will be described below with reference to FIG. 3. FIG. 3 is a schematic cross-sectional view taken along the line III-III of FIG. 2. As shown in FIG. 3, the liquid crystal display device 100 is configured to include the element substrate 10 and the opposite substrate 30 having a liquid crystal layer 40 interposed therebetween.

In this practical example, the element substrate 10 includes one of the scanning lines 121 (i.e., the gate electrode 20g), a gate insulating layer 15, a semiconductor layer 20a, one of the data lines 111 (i.e., the source electrode 20s), the drain electrode 20d, an inter-layer insulating film 16, a planarization layer 17, a reflecting layer 18, the pixel electrode 11, and an alignment film 19, which are formed sequentially on the liquid crystal layer 40 side surface of a planar plate 14 composed of a glass material.

The one of the scanning lines 121 (i.e., the gate electrode 20g), the one of the data lines 111 (the source electrode 20s) and the drain electrode 20d are composed of a metallic material (for example, aluminum). Moreover, the gate insulating layer 15 is composed of, for example, silicon oxide, the semiconductor layer 20a being composed of a semiconductor, such as amorphous silicon or polysilicon, and the inter-layer insulating film 16 is composed of, for example, silicon oxide.

The planarization layer 17 is formed by using a resin having transparency (for example, an acrylic resin or a UV curable resin having positive or negative photosensitivity). In addition, the thickness of the planarization layer 17 to be formed is, for example, approximately 1 μm to 3 μm. Further, concave portions 17S are formed on the flat planar surface located at the liquid crystal layer 40 side of the planarization layer 17 in an area portion corresponding to the above-described light-reflecting display area R within the pixel area. A forming method of the concave portions 17S will be described later.

Furthermore, within the light-reflecting display area R, the reflecting layer 18 is formed so as to follow the shapes of the concave portions 17S. The reflecting layer 18 is composed of a material, such as aluminum, a metal alloy of aluminum and copper, or a metal alloy of aluminum and neodymium. Further, the pixel electrode 11 composed of a material having transparency (for example, ITO) is formed so as to cover the reflecting layer 18 and extend across an area portion corresponding to the pixel area. The pixel electrode 11 is electrically connected to the drain electrode 20d via the contact hole CH1.

The alignment film 19 is formed on the liquid crystal layer 40 side surface of the pixel electrode 11 so as to cover at least the pixel electrode 11. The alignment film 19 is composed of a polyimide resin.

In contrast, in this practical example, the opposite substrate 30 includes a light-shielding layer 32, a filter layer 33, a common electrode 34 and an alignment film 35, which are formed sequentially on the liquid crystal layer 40 side surface of a planar plate 31 composed of a glass material.

The filter layer 33 is composed of a material, such as an acrylic resin, and contains a color material corresponding to a color to be displayed by the currently-targeted pixel. The common electrode 34 is composed of a material having transparency (for example, ITO), and is formed so as to be an electrode extending uniformly and continuously and covering the light-shielding layer 32 and the filter layer 33. The alignment film 35 is composed of, for example, a polyimide resin.

The liquid crystal display device 100 is formed by bonding the element substrate 10 and the opposite substrate 30 provided with such a configuration as described above to each other, so as to have the liquid crystal layer 40 interposed therebetween, and further, by bonding polarization plates 44 and 45 to respective side surfaces opposing the liquid crystal layer side surfaces of the element substrate 10 and the opposite substrate 20. As a result, in the liquid crystal display device 100 formed in such a way as described above, within a pixel area where the filter layer 33 is formed, the light-transmitting display area T, within which images are displayed by optically modulating light rays propagating through from the element substrate 10 side to the opposite substrate 30 side, and the light-reflecting display area R, within which images are displayed by optically modulating outside light rays incident from the opposite substrate 30 side to the element substrate 10 side, are included.

In the liquid crystal display device 100 according to this practical example, the liquid crystal layer 40 interposed between the element substrate 10 and the opposite substrate 30 is formed so as to be of an approximately constant thickness DD, differing from the variation of the thickness of the liquid crystal layer 40 due to shapes of the concave and convex portions, resulting from the technology disclosed in JP-A-2003-215317, and thus, within the light-reflecting display area R where the concave portions 17S are formed, differences in the light path lengths of light rays propagating through the liquid crystal layer 40 are unlikely to be caused. As a result, the probability of arising of the coloring phenomenon associated with the reflected light rays due to optical retardation of the liquid crystal layer 40 is reduced.

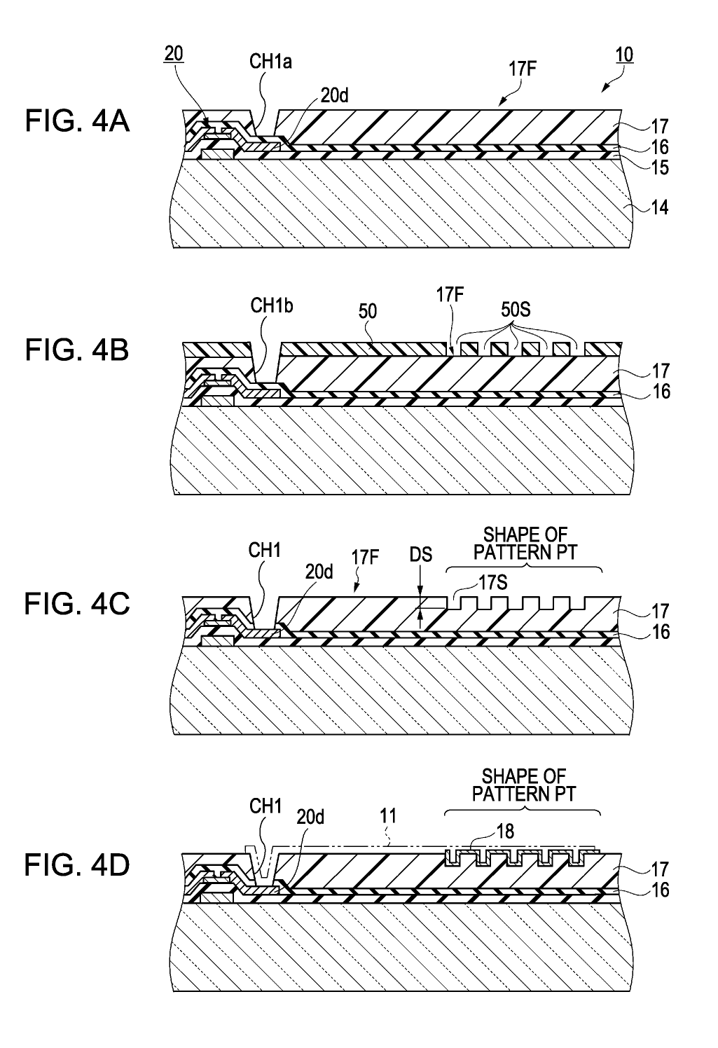

Next, a forming process of the light-reflecting display area R, within which the differences in the light path lengths of light rays propagating through the liquid crystal layer 40 is unlikely to be caused, will be described below with reference to FIGS. 4A to 4D. FIGS. 4A to 4D are process diagrams sequentially illustrating processes of forming concave portions 17S and the reflecting layer 18 in the element substrate 10. Hereinafter, description will be made sequentially in accordance with FIGS. 4A to 4D.

Firstly, FIG. 4A is a process diagram illustrating a condition in which elements up to the planarization layer 17 having a flat planar surface 17F are formed on the planar plate 14. At a position overlapping the drain electrode 20d in plan view, a contact hole CH1a, through which the inter-layer insulating film 16 functioning as an insulating layer is exposed, is formed by performing exposure and development of the planarization layer 17. The thin film transistor 20, the gate insulating layer 15, the inter-layer insulating film 16 and the planarization layer 17 can be formed by employing a manufacturing method the same as or similar to one known to those skilled in the art, such as a method disclosed in JP-A-2003-215317 described above. Therefore, description of the manufacturing method of these elements will be omitted hereinafter.

Subsequently, as shown in FIG. 4B, on the flat planar surface 17 of the planarization layer 17, a resist film 50, resulting from removing of portions corresponding to a contact hole CH1b and prescribed area portions 50S by means of development, is formed. As is obvious, a detailed manufacturing process of forming the resist film 50 is such that, a resist material is coated on the flat planar surface 17F of the planarization layer 17 by employing, for example, a spin coat method, and then, the flat planar surface 17F is exposed by using an exposure mask, and subsequently, is developed so that the resist material coated on portions corresponding to the contact hole CH1b, through which the inter-layer insulating film 16 is to be exposed, and prescribed area portions 50S are removed.

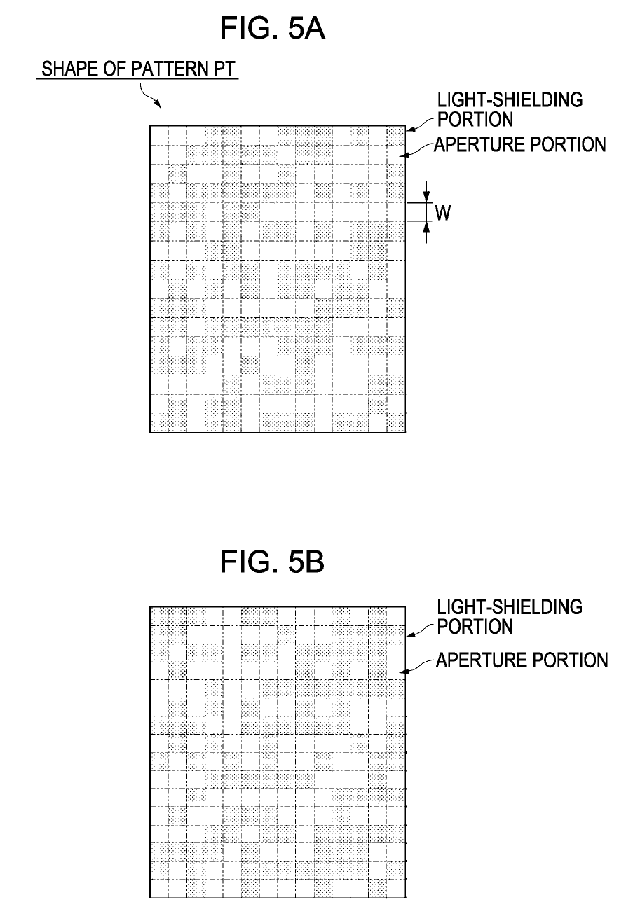

As the exposure mask, in the case where a positive-type resist from which exposed portions thereof are removed is used, aperture portions to be removed by means of development, which correspond to the area portions 50S, are formed so as to represent a prescribed shape of pattern. Examples of this shape of pattern are shown in FIGS. 5A and 5B. In FIG. 5A, a shape of pattern formed on an area to be masked, corresponding to the light-reflecting area R, is partially shown, and includes an aperture portion constituted by individual outlined portions shown in FIG. 5A and a light-shielding portion constituted by individual shaded portions shown in FIG. 5A.

As shown in FIG. 5A, the aperture portion includes a plural of aperture portion units each forming a quadrilateral shape, which are disposed on a plane so as to form a random pattern. As will be described below, by using such an exposure mask having an aperture portion in which a plurality of aperture portion units form a random pattern, it is possible to form a reflecting layer having a good light reflecting and scattering characteristic on the surface of the planarization layer 17 within the light-reflecting display area. Further, it is possible to easily change (i.e., customize) the shape of pattern formed by the concave portions by changing the exposure mask in which a pattern for etching the resist material is formed. As a result, since it is possible to change the light scattering characteristic by changing the shape of pattern formed by the concave portions, it is possible, for example, to provide a liquid crystal display device including a light-reflecting display portion having a light scattering characteristic in accordance with a request from a user of the liquid crystal display device. Additionally, in this practical example, the aperture portion unit is a square in shape, and the length W of a side of the square is determined so as to obtain a good light reflecting and scattering characteristic. In addition, in this practical example, the length W is determined so as to be less than 2 μm.

FIG. 5B is a diagram illustrating a shape of pattern resulting from reversing of a relation between the aperture portion and the light-shielding portion shown in FIG. 5A. It is possible to use an exposure mask formed by reversing the aperture portion in such a way as described above. As is obvious, this reversed shape of pattern can be used in the case where a negative-type resist, from which non-exposure portions are removed, is used.

Here, it is preferable to form the resist film 50 by using a resist material so that etching of the resist material can be proceeded at an etching rate higher than the etching rate at which etching of a material of the planarization layer 17 is proceeded, and further, can be performed more selectively than etching of the material of the planarization layer 17. In this way, since, during a process of development of the resist film 50, the planarization layer 17 is prevented from being etched further subsequent to completion of removing of the resist material coated on the area portions 50S, it is possible to appropriately perform control of the depth of the concave portions formed in the planarization layer 17 during a subsequent manufacturing process.

Let us return to FIGS. 4A to 4D, and as shown in FIG. 4C, an etching process of the planarization layer 17 and the inter-layer insulating film 16 is performed. More specifically, by means of dry etching using the resist film 50 shown in FIG. 4B as an exposure mask, an etching process of the planarization layer 17 and the inter-layer insulating film 16 is performed. In this way, increasing of the etching processes can be suppressed.

As known to those skilled in the art, the dry etching enables realization of an anisotropic etching in which etching is performed in a constant direction by, for example, causing ions to be collided with a target for etching. As a result, the concave portions 17S, each having a constant depth and including a shape of pattern approximately the same as the shape of pattern of the aperture portion formed in the resist film 50, are formed in the planarization layer 17. In addition, etching methods other than the dry etching method, such as an anisotropic wet etching or a laser etching, which enable forming of the concave portions 17S each having a constant depth and including a shape of pattern approximately the same as the shape of pattern of the aperture portion formed in the resist film 50, may be used.

The concave portions 17S are formed by performing etching of the planarization layer 17 up to a depth DS extending from the flat planar surface 17F. In this case, the inter-layer insulating film 16 is formed so as to have a prescribed thickness which allows itself to be etched away before the depth resulting from etching of the concave portions 17S reaches the depth DS. Therefore, even after the inter-layer insulating film 16 is etched away, the drain electrode 20d is dry-etched for a certain period of time, however, since the drain electrode 20d is composed of a metallic material, the amount of a portion of the drain electrode 20d subjected to etching is significantly small, and thus, no functional disadvantage arises.

The bottom of each of the concave portions 17S formed by etching is formed so as to be approximately flat without any corner droop. Therefore, allowing light rays to be reflected by the flat planar surface 17F and the bottoms of the concave portions 17S causes interferences between two groups of light rays, one being light rays reflected by the flat planar surface 17F, the other one being light rays resulting from such an operation that, in which incident light rays are inputted to the concave portions, and then, are reflected by and returned from the bottoms of the concave portions. In this case, phases of the light rays reflected by the bottoms of the concave portions 17S are shifted due to a distance difference from the flat planar surface 17F to the bottoms of the concave portions 17S. As a result, as known to those skilled in the art, in the area portion where the concave portions 17S are formed, a light diffraction phenomenon, in which light axes of the reflected light rays are caused to be bended, arises.

In order to ensure that the light diffraction phenomenon steadily occurs, in this practical example, as shown in FIG. 4D, a reflecting layer 18 is formed in the area having the concave portions 17S formed therein, that is, in the area having the above-described shape of pattern formed therein. More specifically, the reflecting layer 18 is formed in the light-reflecting display area R, in which the concave portions 17S are formed so as to form a prescribed random pattern, by means of a masking vapor deposition. As a result, in the area having the concave portions 17S formed therein, that is, in the light-reflecting display portion R, a so-called diffractive optical element (DOE), which causes the light diffraction phenomenon, is formed. In addition, in order to prevent variation (i.e., reduction, in this case) of the thickness of the liquid crystal layer 40, it is preferable to make the thickness of the reflecting layer 18 to be formed be as small as possible enough for the reflecting layer 18 to fulfill a light reflecting function (for example, approximately from 10 nm to 100 nm). Subsequently, the pixel electrode 11, which is denoted by a chain double-dashed line in FIG. 4D, is formed, and then, the element substrate 10 reaches a final condition shown in FIG. 3.

Here, the prescribed depth DS of each concave portion 17S will be supplementarily described below. The depth DS is a depth which complies with a condition causing the light diffraction phenomenon in which light axes of the reflected light rays are caused to be bended, resulting from interference between light rays reflected by the bottoms of the concave portions 17S and light rays reflected by the flat planar surface 17F. As a depth which causes the light diffraction phenomenon, for example, a depth h complying with a condition represented by the following formula (1), which is disclosed in JP-A-2000-2875, is well known to those skilled.

n×h=λ/4 (1)

Here, n is a refractive index of a liquid crystal layer, and λ is a wavelength of an incoming light ray.

For the liquid crystal display device 100, in general, incident light is visible one, and thus, light rays having a wavelength of approximately 400 nm to 800 nm are used. In addition, the refractive index n of a liquid crystal layer is a value which depends on a material of the liquid crystal. For example, assuming that n=1 and λ=400 nm as an example, the depth h resulting from calculation by using the formula (1) is as follows: h=100 nm. Additionally, in this practical example, the depth DS is determined to be 100 nm.

Therefore, after completion of forming the reflecting layer 18, in the reflecting layer 18, steps each having a height of approximately 100 nm are formed along the concave portions 17S having depths of approximately 100 nm. As a result, within an area where the concave portions 17S are formed, the reflecting layer 18 including a prescribed shape of pattern PT is formed

Additionally, in general, the depth DD of the liquid crystal layer 40 is determined to be, for example, a value of the order of μm (for example, approximately 1 μm to 5 μm). In comparison with this value of the order of μm, according to the formula (1), the size of each of the steps included in the reflecting layer 18 formed within the light-reflecting display area R having the concave portions 17S formed therein is a value of the order of approximately 100 nm (i.e., 0.1 μm), and thus, becomes less than or equal to approximately 1/10 of the depth of liquid crystal layer 40. Accordingly, light rays propagating through the liquid crystal layer 40 are unlikely to have differences in light paths thereof, and as a result, the probability of arising of a coloring phenomenon associated with the reflected light rays due to optical retardation of the liquid crystal layer 40 is reduced.

As described above, in the liquid crystal display device 100 according to this practical example, the light-reflecting display area R, which has the concave portions 17S covered by the reflecting layer 18 and functions as an area incorporating therein a so-called diffractive optical element (DOE) causing the light diffractive phenomenon, becomes an area reflecting light rays diffusely, and thus, enables improving of a visibility angle characteristic associated with a display function provided by the liquid crystal display device 100. In this case, since the depth DS, extending in a vertical direction from the flat planar surface 17F, of the concave portions 17S which cause the light diffractive phenomenon, is significantly small in size, compared with the thickness DD of the liquid crystal layer 40, the area in which the concave portions 17S are formed can be regarded as an area being approximately planar. As a result, the thickness of the part of the liquid crystal layer 40 existing within the light-reflecting display area becomes substantially approximately constant. Accordingly, the probability of arising of misalignments in optical characteristics associated with the reflected light rays due to optical retardation of the liquid crystal layer, such as the resultant coloring phenomenon, is reduced. Furthermore, the above-described formation, which allows light rays to be scattered by forming the concave portions in the planarization layer without providing such an additional structure as proposed in JP-A-2000-2875, leads to an advantage in that complexity of the manufacturing procedure of the liquid crystal display device is not increased.

Hereinbefore, an embodiment of the invention has been described by way of a practical example thereof, however, the invention is not limited to such a practical example, but, obviously, can be applied to various embodiments falling within the scope not departing from the intent of the invention. Hereinafter, other embodiments will be described by way of modified practical examples.

### FIRST MODIFIED PRACTICAL EXAMPLE

In the above-described practical example, as shown in FIG. 3, the pixel electrode 11 is formed so as to cover the reflecting layer 18 in the pixel area. Due to this formation, in more detail, the thickness of a part of the liquid crystal layer 40 existing within the light-transmitting display area T is different from the thickness of another part of the liquid crystal layer 40 existing within the light-reflecting display area R by the thickness of the reflecting layer 18. Therefore, the above-described difference in thickness between the two parts of the liquid crystal layer 40 leads to a difference in optical retardation between the two parts of the liquid crystal layer 40, and thus, for example, is likely to lead to a disadvantage in that color differences occur between displaying colors resulting from light rays emitted from the light-transmitting display area T and displaying colors resulting from light rays emitted from the light-reflecting display area R.

Additionally, as described in the above-described practical example, the reflecting layer 18 is composed of a metallic material, such as aluminum, and thus, the reflecting layer 18 has electrical conductivity. Therefore, as an modified practical example, the reflecting layer 18 may be configured to function as at least one part of the pixel electrode 11. This configuration causes the dimensions of an area of the reflecting layer 18 overlapped by the pixel electrode 11 to be reduced, and thus, allows the thickness of a part of the liquid crystal layer 40 within the light-transmitting area T and the thickness of another part of the liquid crystal layer 40 within the light-reflecting area R to be substantially the same.

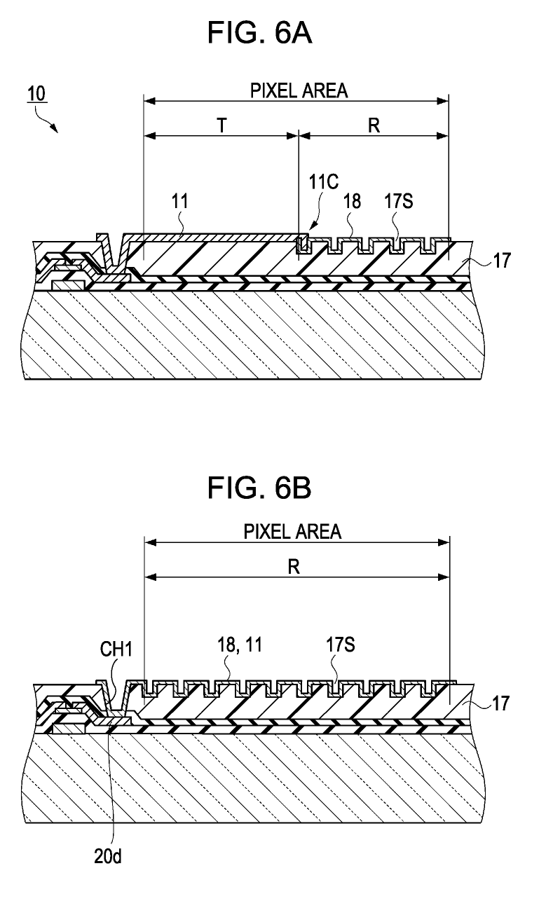

FIGS. 6A and 6B are diagrams each illustrating a configuration of the element substrate 10 in an example to which this modified practical example is applied. FIG. 6A is a diagram in the case where this modified practical example is applied to the transflective liquid crystal display device 100, and FIG. 6B is a diagram in the case where this modified practical example is applied to the reflective liquid crystal display device 100.

Firstly, as shown in FIG. 6A, in the case of the transflective liquid crystal display device 100, an overlapping portion 11C, resulting from minimizing the dimensions of a part of the pixel electrode 11 overlapping the reflecting layer 18 to an extent which allows the part of the pixel electrode 11 to be electrically connected to the reflecting layer 18, is formed on an edge portion of the reflecting layer 18. As a result, within the most part of the light-reflecting area R excluding a part where the overlapping portion 11C exists, a height extending beyond the planarization layer 17 consists of only the thickness of the reflecting layer 18. Accordingly, it follows that it is possible to cause the height extending beyond the planarization layer 17 within the light-reflecting area R to be approximately the same as the height extending beyond the planarization layer 17 within the light-transmitting area T, which consists of the thickness of the pixel electrode 11.

For example, in the case where the thickness of the pixel electrode 11 is formed so as to be approximately 100 nm, the thickness of the reflecting layer 18 may be formed so as to be 100 nm. Additionally, as described above, the reflecting layer 18 is formed in the concave portions 17S, and therefore, within portions where the reflecting layer 18 is formed so as to follow the shapes of the concave portions 17S, it is preferable to select a value the most approximate to the thickness of the pixel electrode 11 as the thickness of the reflecting layer 18.

Alternatively, as shown in FIG. 6B, in the case of the reflective liquid crystal display device 100, in which the whole pixel area is formed so as to be a light-reflecting display area, the pixel electrode 11 may be formed of the reflecting layer 18. Obviously, in this case, the concave portions 17s are formed in the whole of the pixel area. Further, via the contact hole CH1, the reflecting layer 18 may be formed so as to be electrically connected to the drain electrode 20d.

As shown in FIG. 6B, in the case of the reflective liquid crystal display device 100, since the reflecting layer 18 can be formed within the whole of the pixel area as the pixel electrode 11, the thickness of the liquid crystal layer 40 is substantially approximately constant within the pixel area. As a result, the probability of arising of misalignments in optical characteristics associated with the reflected light rays due to optical retardation of the liquid crystal layer, such as the resultant coloring phenomenon, is reduced.

### SECOND MODIFIED PRACTICAL EXAMPLE

In the above-described practical examples, the liquid crystal display advice 100 has been described assuming that the liquid crystal display device 100 adopts a vertical electric field scheme, such as the twisted nematic (TN) scheme, the vertical alignment (VA) scheme, or the electrically controlled birefringence (ECB) scheme, in which an electric field is applied between the pixel electrode 11 formed in the element substrate and the common electrode 34 formed in the opposite substrate 30, however, embodiments of the invention are not limited to the liquid crystal display devices adopting these schemes, but can be applied to liquid crystal display devices adopting a horizontal electric field scheme, such as the fringe-field switching (FFS) scheme or the in-plane switching (IPS) scheme, in which alignment control of liquid crystal molecules are performed by generating an electric field relative to the liquid crystal layer 40 in a direction parallel with the element substrate 10.

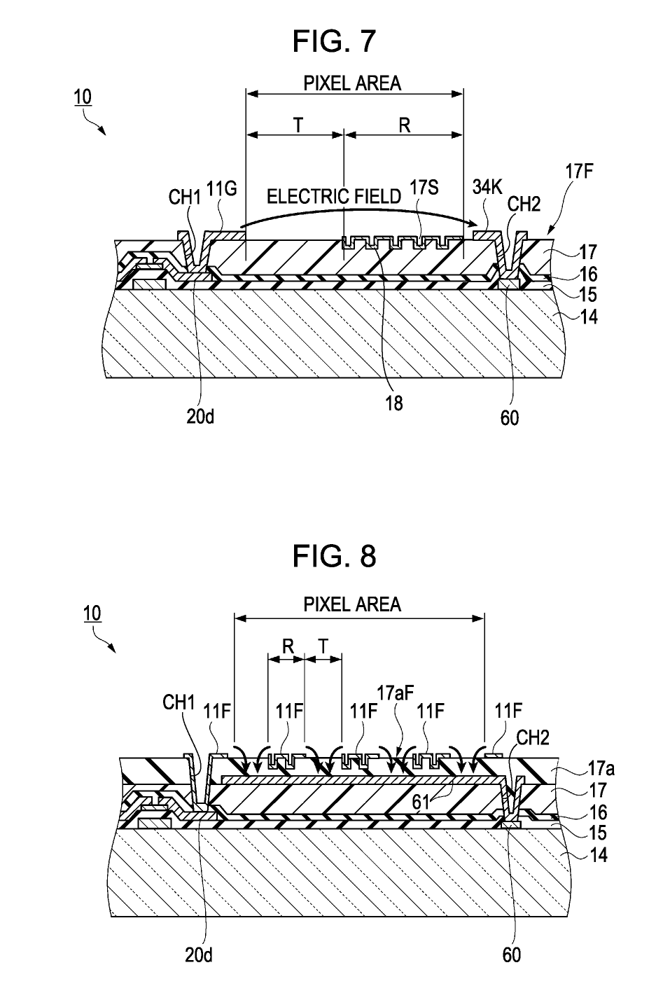

As an example, the liquid crystal display device 100 in the case where it adopts the IPS scheme will be described below with reference to FIG. 7. FIG. 7 is a schematic diagram illustrating a configuration of the element substrate 10, which is associated with only elements different from those included in the above-described practical examples. In addition, the configuration of the opposite substrate 30 in this case is the same as that in the case of the above-described practical examples, except for a configuration in which the common electrode 34 is not formed in the opposite substrate 30. Therefore, the opposite substrate 30 will be omitted from the following description.

As shown in FIG. 7, in the element substrate 10, common wiring 60 is formed on the planar plate 14. Further, a common electrode 34K, which is electrically connected to this common wiring 60 via a contact hole CH2 formed through the gate insulating layer 15 and the inter-layer insulating film 16, is formed on the flat planar surface 17F of the planarization layer 17. In contrast, the pixel electrode 11G is electrically connected to the drain electrode 20d via the contact hole CH1 formed through the inter-layer insulating film 16, and is formed on the flat planar surface 17F of the planarization layer 17 in the same manner as or in a manner similar to that in the case of the common electrode 34K. Therefore, as shown in FIG. 7, the element substrate 10 provided with such a configuration as described above causes an electric field extending in a direction along the flat planar surface 17F (i.e., a horizontal electric field) to be generated between the pixel electrode 11G and the common electrode 34K, and results in being a substrate included in the liquid crystal display device adopting the IPS scheme. In addition, the pixel electrode 11G and the common electrode 34K are composed of a metallic material, such as aluminum, and are located so as not to be overlapped with the pixel area in plan view.

In this modified practical example, in the element substrate included in the liquid crystal display device adopting the IPS scheme, in order to have a prescribed shape of pattern within an area corresponding to the light-reflecting display area R, the concave portions 17S are formed by performing dry etching in the same way as or in a way similar to that in the above-described practical examples. Further, in the same way as or in a way similar to that in the above-described practical examples, within the area corresponding to the light-reflecting area R, the reflecting layer 18 is formed so as to cover the concave portions 17S formed during the previous manufacturing process. As a result, the diffractive optical element (DOE) is incorporated in the light-reflecting area R.

By providing such a configuration as described above, a height extending beyond the planarization layer 17 within the light-reflecting area R results in causing a difference of only the thickness of the reflecting layer 18, compared with the height of the planarization layer 17 within the light-transmitting area T. Therefore, as described above, it is possible to make the thickness of the liquid crystal layer 40 within the light-transmitting display area T be approximately the same as that within the light-reflecting display area R. As a result, the probability of arising of misalignments in optical characteristics associated with the reflected light rays due to optical retardation of the liquid crystal layer, such as the resultant coloring phenomenon, is reduced. As described above, also in the liquid crystal display device adopting the IPS scheme, it is possible to provide a liquid crystal display device having a good reflection and scattering characteristic owing to the diffractive optical element, and further, being capable of reducing the probability of arising of misalignments in optical characteristics associated with the reflected light rays due to optical retardation of the liquid crystal layer 40, such as the resultant coloring phenomenon.

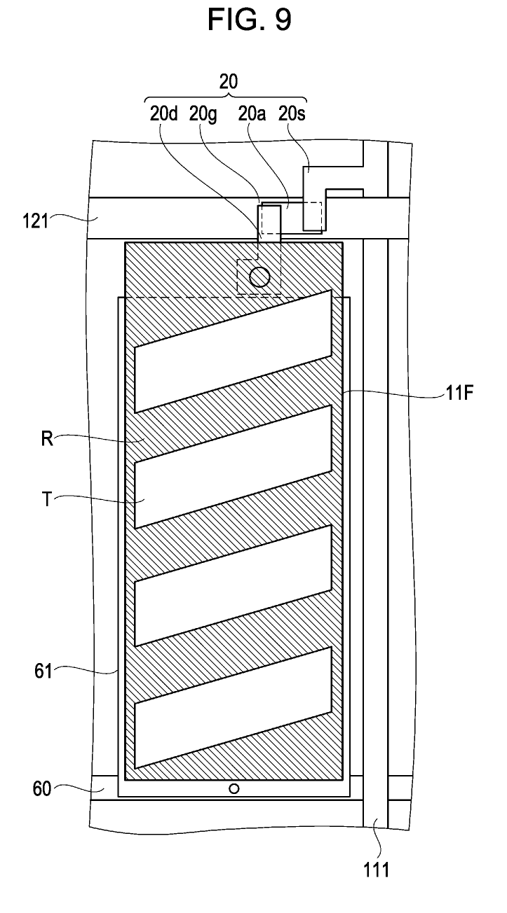

Next, the liquid crystal display device 100 in the case where it adopts the FFS scheme will be described below with reference to FIGS. 8 and 9. FIG. 8 is a schematic diagram illustrating a configuration of the element substrate 10 in a sectional view. FIG. 9 is a schematic diagram illustrating a configuration of the element substrate 10 in a direction toward a pixel area, i.e., in plan view. In addition, in the same way as that employed in FIG. 7, FIG. 8 shows only elements different from those included in the above-described practical examples. Further, the configuration of the opposite substrate 30 in this case is the same as that in the case of the above-described practical examples, except for a configuration in which the common electrode 34 is not formed in the opposite substrate 30. Therefore, the opposite substrate 30 will be omitted from the following description.

As shown in FIG. 8, in the element substrate 10, the common wiring 60 is formed on the flat planar plate 14. Moreover, on the planarization layer 17, a common electrode 61, which is electrically connected to this common wiring 60 via the contact hole CH2, is formed of an electrode extending uniformly and continuously, and having dimensions larger than those of the pixel area. In contrast, a pixel electrode 11F is electrically connected to the drain electrode 20d via the contact hole CH1 and is formed on a surface 17aF of an insulating layer 17a, which is composed of a material, such as silicon nitride. The surface 17aF is also formed on the planarization layer 17, and thus, results in being substantially planar.

In this modified practical example, it is assumed that the pixel electrode 11F functions as the reflecting layer 18. Further, as shown in FIG. 9, the pixel electrode 11F has a plurality of slit-shaped aperture portions, and is formed so as to overlap the common electrode 61 in plan view within the pixel area. As a result, as shown in FIG. 8, the element substrate 10 provided with such a configuration as described above causes a horizontal electric field (which is illustrated, for the sake of convenience in drawing, as an electric field extending in an oblique direction, as denoted by arrows in FIG. 8) to be generated between the pixel electrode 11F (i.e., the reflecting layer 18) and the common electrode 61, and results in being a substrate included in the liquid crystal display device adopting the FFS scheme. In addition, the pixel electrode 11F is an element the same as the reflecting layer 18, and thus, is composed of a metallic material, such as aluminum, and further, the common electrode 61 is composed of a material having light-transparency.

In such a substrate included in the liquid crystal display device adopting the FFS scheme, according to this modified practical example, within the pixel area, the concave portions 17S having a prescribed shape of pattern are formed by means of dry etching, in the same way or in a way similar to that in the practical examples described above, in areas on the surface 17aF of the insulating layer 17a, which correspond to at least electrode areas each being located between the silt-shaped aperture portions of the pixel electrode 11F. Further, in the same way as or in a way similar to that in the above-described practical examples, the electrode areas each having the concave portions 17S formed therein are formed by forming the pixel electrode 11F having the silt-shaped apertures formed therein so as to cover the concave portions 17S formed during the previous process. As a result, as shown in FIG. 9, the slit-shaped aperture portions and the electrode portions each being located between the slit-shaped aperture portions result in being the light-transmitting areas T and the light-reflecting areas R, respectively.

By providing such a configuration as described above, a height extending beyond the insulating layer 17a within the light-reflecting area R results in causing a difference up to the thickness of the pixel electrode 11, compared with the height of the insulating layer 17a within the light-transmitting area T. Therefore, as described above, it is possible to make the thickness DD of the liquid crystal layer 40 within the light-transmitting display area T be approximately the same as the thickness of the liquid crystal layer 40 within the light-reflecting display area R. As a result, the probability of arising of misalignments in optical characteristics associated with the reflected light rays due to optical retardation of the liquid crystal layer 40, such as the resultant coloring phenomenon, is reduced. As described above, also in the liquid crystal display device adopting the FFS scheme, it is possible to provide a liquid crystal display device having a good reflection and scattering characteristic owing to the diffractive optical element, and further, being capable of reducing the probability of arising of misalignments in optical characteristics associated with the reflected light rays due to optical retardation of the liquid crystal layer, such as the resultant coloring phenomenon.

Additionally, in the liquid crystal display device adopting the FFS scheme, even portions of the liquid crystal layer 40 above the electrode areas each being located between the slit-shaped portions formed in the pixel electrode 11F are likely to respond to an electric field and be optically modulated, and thus, operate as a portion of the pixel, in which optical modulation is caused. Therefore, in the liquid crystal display device 100 according to the above-described practical examples, the pixel area is configured to be divided into two areas, one being the light-reflecting display area R, the other one being the light-transmitting display area T, however, in this modified practical example, by allowing the electrode areas between the slit-shaped portions formed in the pixel electrode 11F to be the light-reflecting display areas R, distributed allocation of the light-reflecting display areas and the light-transmitting display areas T within the pixel area can be realized. As a result, this distributed allocation of the light-reflecting display areas R and the light-transmitting display areas T within the pixel area leads to an advantage in that the liquid crystal display device adopting the FFS scheme is capable of displaying images by using the whole of each pixel area, regardless of two display modes employed in the liquid crystal display device adopting the FFS scheme, one being a light-reflecting display mode, the other one being a light-transmitting display mode.

### OTHER MODIFIED PRACTICAL EXAMPLES

In the above-described practical examples, explanation has been made assuming that the reflecting layer 18 is formed subsequent to forming the concave portions 17S on the flat planar surface 17F of the planarization layer 17, however, a manufacturing method of the liquid crystal display device is not limited to this method, but the reflecting layer 18 may not be formed. For example, in the case where the planarization layer 17 is composed of a material of a refractive index higher than that of the liquid crystal layer 40, as a result, the planarization layer 17 has a light reflecting function. In this case, it is not necessary to form the reflecting layer 18.

Further, in the above-described practical examples, it is assumed that, in order to suppress increasing of the number of etching processes, a dry etching process of forming the concave portions 17S in the planarization layer 17 is performed concurrently with a dry etching process with respect to the inter-layer insulating film 16 performed to expose the drain electrode 20d, however, as is obvious, the manufacturing method of the liquid crystal display device is not limited to this process. For example, in the case of the liquid crystal display device adopting the IPS scheme in the above-described second modified practical example, the dry etching process of forming the concave portions 17S in the planarization layer 17 may be performed concurrently with the etching process performed to expose the common wiring 60. As a matter of course, the dry etching process of forming the concave portions 17S in the planarization layer 17 may be independently performed.

Moreover, in the above-described second modified practical example, in the case of the liquid crystal display device adopting the IPS scheme, in some cases, within the pixel area, the pixel electrode 11G and the common electrode 34K are formed on the planarization layer 17 so as to have comb-teeth shaped terminals, respectively, and are arranged so as to be mutually engaged between the comb-teeth shaped terminals, thereof on the flat planar plate 17F. In this case, it is preferable to form the reflecting layer 18 so that, with respect to the mutually engaged comb-teeth shaped terminals, the light-transmitting areas T and the light-reflecting areas R are alternatively allocated. Alternatively, it is preferable to form the reflecting layer 18 so that, with respect to the mutually engaged comb-teeth shaped terminals, one of the light-reflecting areas R and one of the light-transmitting areas T are allocated in a longitudinal direction of each of the mutually engaged comb-teeth shaped terminals. By providing such a way, in the same way as or in a way similar to that in the case of the liquid crystal display device adopting the FFS scheme in the above-described second modified practical example, distributed allocation of the light-reflecting display areas R and the light-transmitting display areas T within the pixel area can be realized. Therefore, this distributed allocation of the light-reflecting display areas R and the light-transmitting display areas T within the pixel area leads to an advantage in that the liquid crystal display device adopting the IPS scheme is capable of displaying images by using the whole of each pixel area, regardless of two display modes employed in the liquid crystal display device adopting the IPS scheme, one being the light-reflecting display mode, the other one being the light-transmitting display mode.

What is claimed is:

1. An electro-optical device comprising:
a pair of substrates,
a liquid crystal layer interposed between the pair of substrates,
two electrodes optically modulating the liquid crystal layer in accordance with an electric field being generated by therebetween,
a planarization layer configured to be included in one substrate from among the pair of substrates, and have a surface including at least one electrode formed thereon from among the two electrodes, and
concave portions configured to be formed in the surface of the planarization layer, and be formed so that the depth of each of the concave portions is appropriate for causing an optical diffraction phenomenon.

2. The electro-optical device according to claim 1, wherein, in the surface of the planarization layer, the concave portions are configured to form a random pattern which specifies a light scattering characteristic.

3. The electro-optical device according to claim 1, further comprising a reflecting layer configured to reflect light rays, be formed on the surface of the planarization layer, and be formed in portions where the concave portions are formed.

4. The electro-optical device according to claim 3, wherein the reflecting layer is configured to form at least one part of the one electrode.

5. The electro-optical device according to claim 3, wherein the one electrode is composed of a transparent material having optical transparency, and
wherein, on the surface of the planarization layer, the reflecting layer is formed within at least one part of an area where the one electrode is formed.

6. A manufacturing method of the electro-optical device set forth in claim 1, comprising:
forming a resist film covering the surface of the planarization layer,
performing etching of the resist film formed thereby, and
forming the concave portions by performing dry etching of the planarization layer, during which the resist film etched thereby is used as an exposure mask.

7. The manufacturing method of the electro-optical device according to claim 6, wherein the forming of the concave portions concurrently includes removing of an insulating film covering an electrode terminal which is configured to supply the one electrode with a voltage causing the electric field to be generated.
